(19) United States
(12) Patent Application Publication
(10) Pub. No.: US 2004/0164271 A1
(43) Pub. Date: Aug. 26, 2004

(54) Method of stabilising an oxidant and a stabilised oxidant

(76) Inventors: Neil Stuart Grant, Garing-On-Thames (GB); Helmut Richard Ohlmeyer, London (GB)

Correspondence Address: SIEBERTH & PATTY, 2924 BRAKLEY DRIVE SUITE A 1, BATON ROUGE, LA, 70816

(21) Appl. No.: 10/473,689

(22) PCT Filed: Mar. 26, 2002
(86) PCT No.: PCT/GB02/01451

(30) Foreign Application Priority Data
Mar. 26, 2001 (GB) 0107531.6

(51) Int. Cl. C09K 3/00

(52) U.S. Cl. 252/182.12

(57) ABSTRACT

The method of the present invention relates to stabilising an oxidant which is dried under vacuum to form a powder. The powder is then sealed in a package under a nitrogen atmosphere. The preferred oxidant is sodium perborate. The invention further relates to the stabilised oxidant.

The present invention relates to a method of stabilising an oxidant, and a stabilised oxidant. The stabilised oxidant is particularly suitable for a chemiluminescence reaction.

The oxidants suitable for stabilisation by the present invention are known to be used as a reagent in luminescence assay such as chemiluminescence and bioluminescence assay. This type of assay is described in EP-A-0116454, the contents of which are hereby incorporated by reference. The unstabilised oxidants tend to loose activity during the period whilst the oxidants are stored. This is a particular problem when the assay is to be conducted outside of the laboratory environment as the reagents cannot then be maintained in stable environments are will be subject to potentially large changes in e.g. temperature.

The stabilised oxidant of the present invention may be used in the determination of the toxicity level in a water sample. In natural water courses such as streams and rivers, the toxicity level will vary greatly from place to place and also depend upon the particular climatic and seasonal variations which occur in the locality. The number and the nature of pollutants is enormous. Each individual pollutant can be tested in a traditional laboratory environment using chromatographic methods and other assay techniques. This is however expensive and time consuming especially when the full range of pollutants is not known prior to testing.

The present invention may be used in an assay for measuring the overall level of pollutants within the liquid. It has been found that the level of light emission from a sample will vary depending upon the total level of pollutants within the water sample. Thus a measurement of the light emission between a sample placed within the luminometer compared to the level of emission from a reference example (deionized water) can provide an accurate indication of the total level of pollutants within the water sample. The test can thus give an overall level of pollutants immediately. This is of particular importance where there has been an accident causing a spillage of pollutants into a water course or where a temporary drinking water supply has been located but requires testing for contamination before use.

The present invention seeks to provide an oxidant which retains activity for an assay over a range of temperatures for a prolonged period.

According to a first aspect of the present invention, there is provided a method of stabilising an oxidant, comprising the steps of:

(i) drying the oxidant under vacuum to form a powder; and

(ii) packaging the powder into a sealed package in an inert atmosphere.

It has been found that oxidants stabilised in this manner retain there activity for unusually long periods compared to un-dried oxidants or oxidants that have been stabilised in other ways.

Normally the inert atmosphere used is nitrogen as this is a convenient gas as it is often available in preparative laboratories.

The oxidant is preferably selected from the group consisting of sodium perborate. The oxidant will often be in solid form prior to step (i), and the present invention then removes the last vestiges of moisture which otherwise degrade the oxidant during storage. As the dried compound is sealed under an inert atmosphere, no moisture can then enter the package to later cause degradation.

The drying step (i) is advantageously conducted at ambient temperature which minimises the chance of product breakdown in the drying stage.

Preferably the method provides an oxidant that retains activity for at least 90 days at 37° C.

It has been found advantageous for the stabilised oxidant to be stored with a drying agent, such as silica gel.

According to a second aspect of the present invention there is provided a stabilised oxidant comprising a dried powder which retains activity for at least 90 days at 37° C. This product is particularly suitable for instances where the reagent will be used in an assay not conducted in a laboratory. In particular the oxidant does not require refrigeration.

The oxidant is preferably selected from the group consisting of: sodium perborate.

According to a third aspect of the present invention there is provided a kit including the oxidant according to second aspect of the invention and one or more of the following components:

a) a detector;

b) as an enzyme reagent;

c) a protein reagent;

d) a buffer solution;

e) luminal and/or indophenol in a pH buffer.

The kit will advantageously comprising all of components (b) to (e). It can significantly increase the profitability of the kit to also include a suitable detector.

The kit preferably comprises a water test kit.

Preferred embodiments of the present invention will now be described with reference to the accompanying drawings, in which:

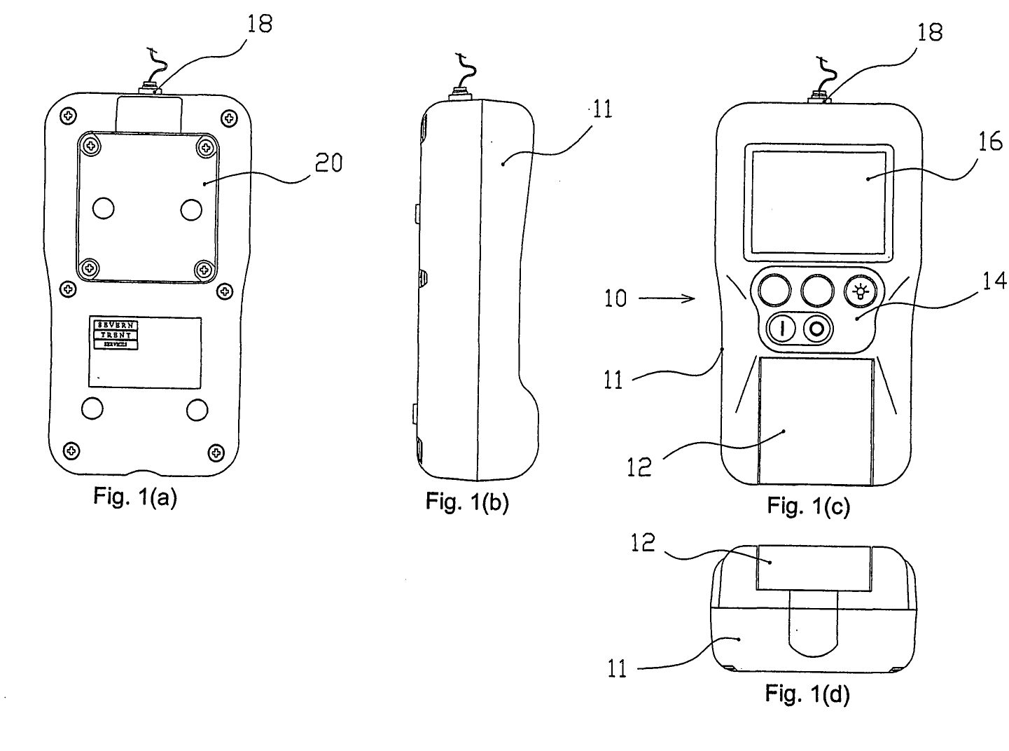

FIG. 1 shows a light detector according to the present invention;

FIG. 1A is a rear view;

FIG. 1B is a side view;

FIG. 1C is a front view, and

FIG. 1D is a bottom view;

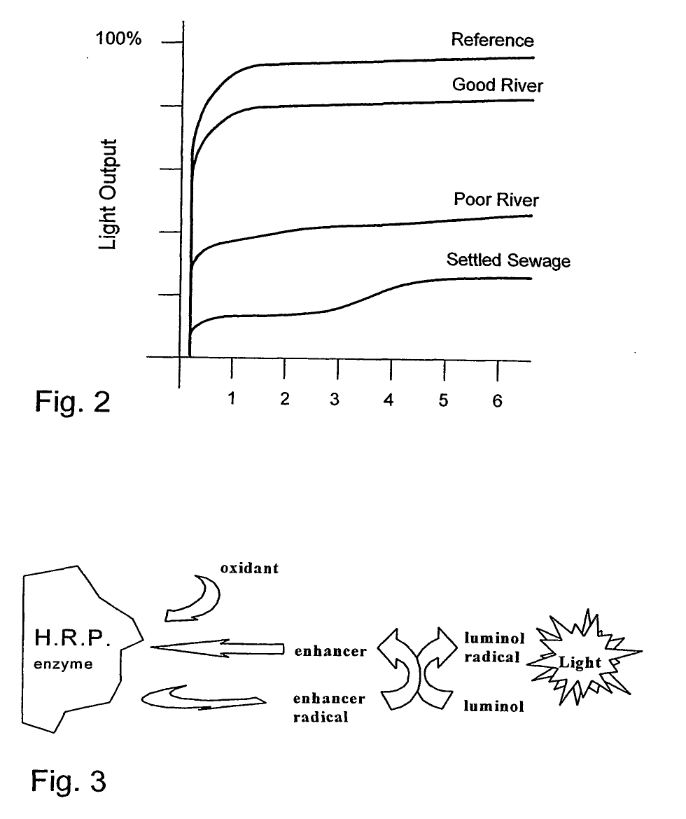

FIG. 2 is a graph showing results taken from a test using the detector according to the present invention;

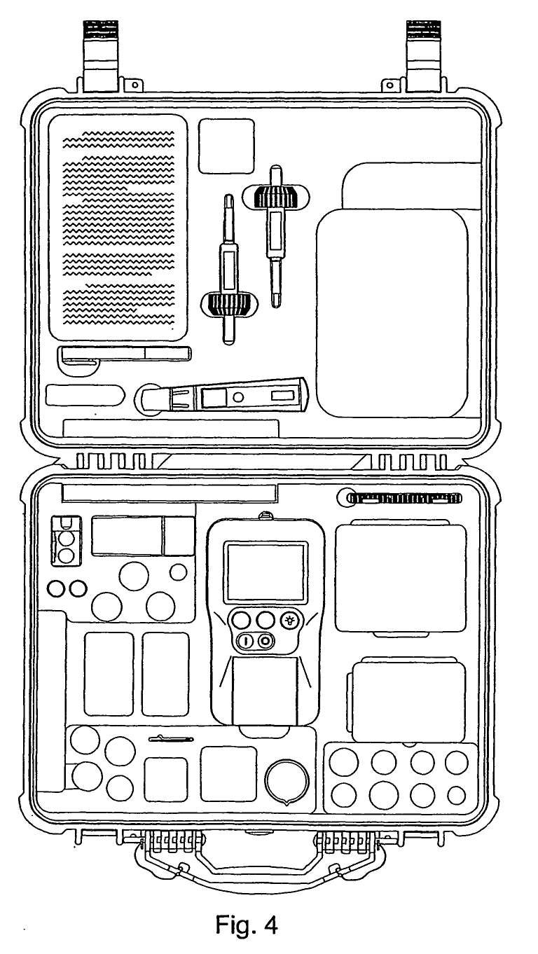

FIG. 3 is an illustration of the assay according to a preferred embodiment of the present invention; and

FIG. 4 is a kit according to a preferred embodiment of the present invention.

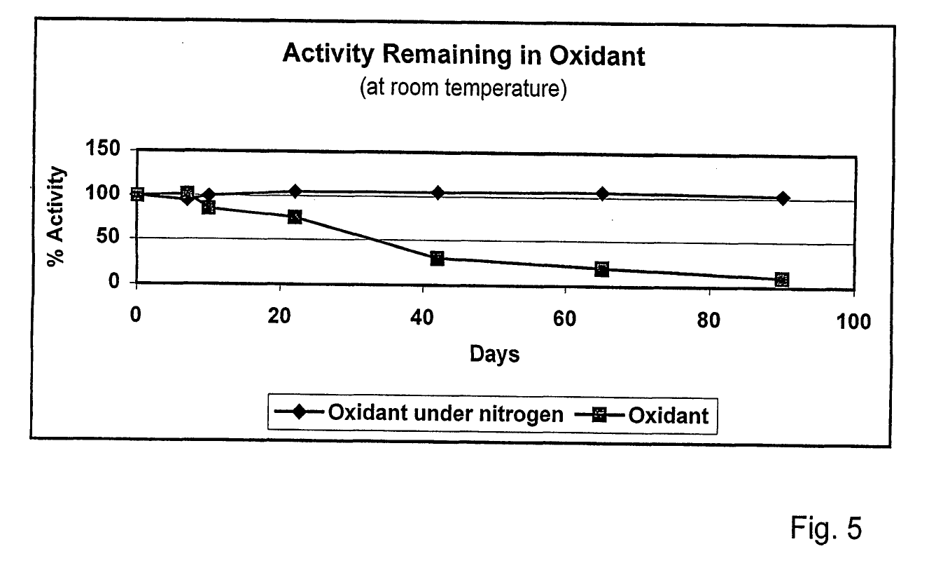

FIG. 5 depicts comparative data of the stabilised compound.

The stabilised oxidants of the present invention are designed for a wide operating temperature range of −20° C. to +50° C.

The oxidant of present invention is preferably used in a detector as shown in FIG. 1. The detector 10 has a housing 11 has a lid 12 which is hingedly retained on the housing 11. The lid 12 is shown in its normal position and is movable to an open position (not shown). The detector 10 has a control panel 14 on which are located the control buttons for the detector. The detector 10 has a display panel 16 which in the illustrated embodiment is an LCD which can graphically show the results obtained.

A communications port 18 is provided at the top of the detector. The housing 11 is a two part housing which is screwed together as shown best in FIGS. 1A and 1B. The rear of the detector includes panel 20 which comprises a cover to the battery enclosure located on the rear of the housing. The battery enclosure is optically isolated from the detector means.

The detector means 30 is located under the lid 12 within the housing 11. FIG. 2 shows a schematic representation of the layout of the detection means 30. The emitter means comprises an LED 32 mounted on an emitter control circuit board 34.

The sensor means comprises a primary diode detector 36 mounted on a sensor circuit board 37 which also has a blind diode detector 38 mounted thereupon. The sensor means is operated so that the blind diode detector 38 compensates for temperature drift thus providing a constant relative zero voltage for the sensor means. In the detector 10 the zero voltage is taken as being ΔA-B. This relative zero can be used with the two diodes which otherwise would not be possible using a single diode. Thus the full voltage range measurement is provided by the detector 10 of the present invention regardless of external temperature variation or other climatic conditions.

The two diodes are selectively chosen for each particular detector 10. The outputs of the diodes are measured with temperature prior to installation. The diode detectors are then chosen by having near identical outputs over a wide range of temperature. The sensor means of the present invention could be used in portable or non-portable detectors.

A sample is input through the port under the lid 12 when the lid 12 have been moved to its open position.

The lid 12 is formed from a molded plastics materials such as nylon 6,6 or polypropylene. The lid 12 includes aluminium casting about which the lid is molded. This aluminium casting 13 acts as an opaque barrier to light being transmitted through the lid 12. It has been found that plastics material alone often allows extremely low light transmission therethrough and thus the aluminium casting 13 is necessary to prevent all light transmission through the lid 12. In this application, no light transmission means no light measurable by the detector 10. The aluminium casting 11 is thick enough so as to be scratch-resistant in as far as that any scratches do not affect the opaque qualities thereof.

In this application permanently opaque means that the body prevents light transmission without degrading over time and with normal use, so being scratch-resistant and knock-resistant. In this regard this is contrasted with a painted or coated surface which may well be formed with minute areas which are uncovered and/or can be scratched in use. Thus a painted or coated surface does not form a permanently opaque coating/layer.

The housing 11 is normally made from a plastics material such as nylon 6,6 or polypropylene. Inside the housing 11 the various components will be mounted upon shock-resistant boards to assist in the robustness of the apparatus. The portable light detectors of the invention are operable independent of an external power supply and/or are battery powered. This is preferred for the electronics to operate at a voltage under 5V preferably 3.2V.

The detector is particularly suitable for conducting luminescence assays of the present invention. For example a chemiluminescence assay.

The reagent of the present invention has particular use in situations where there is a need to know the pollution levels within water. Pollutants are generally measured by the capacity to reduce available oxygen and therefore the related toxicity to life within the water. Free radicals contained in urine, faeces, etc consume available oxygen reducing the amount for other living organisms such as plants and fish. Oxygen uptake is generally measured by the biological oxygen demand (BOD) and the chemical oxygen demand (COD). The BOD₅ test, although relatively simple, takes five days to yield the result. This is not only fairly costly but can also lead to difficulties in preventing further pollution and degradation of a water course. Alternatively, potentially toxic substances can be measured specifically by expensive laboratory based equipment such as chromatography or plasma apparatus providing one knows what contaminants are contained within the test sample.

The detector 10 of the present invention quickly and simply provides an accurate and immediate indication of water quality by conducting a luminescence reaction. The preferred embodiment of the present invention uses chemiluminescence. The technique has been used extensively in clinical and medical fields in diagnostic assays and in the determination of specific disease such as rheumatoid arthritis. The technique is based upon the reaction of luminal and an oxidant in the presence of a catalyst enzyme, such as horseradish peroxidase (HRP). When an enhancer is added such as p-indophenol the light produced is stable and can be measured.

A schematic representation is shown in FIG. 3. Any free radical scavengers or antioxidants such as those contained in faeces or urine will interfere with this reaction thus reducing the light emission. Substances such as phenols, amines and heavy metals which attack the enzyme itself which will also reduce light output. When the light output is plotted over time characteristic curves are produced which enable rapid finger-printing.

FIG. 2 shows a theoretical results profile for settled sewage, poor river, good river and a reference based on the above reaction.

Further details of this type of assay can be found in EP 0 116 454 the contents of which are incorporated herein by reference. The present invention uses an advancement of the reactions described therein with some of the components being stabilised. Stabilisation techniques for the enzyme component are disclosed in PCT/GB89/01346 and PCT/GB91/00443, the contents of which are also herein incorporated by reference.

The reaction requires three reagents. Reagent (a) is luminal and p-indophenol. Reagent (b) the oxidant and Reagent (c) the HRP enzyme.

The present invention relates to the stabilisation of reagent (b). The method of the present invention requires the oxidant to be dried under vacuum to form a powder. The drying step is preferably conducted at ambient temperature, e.g. room temperature of between 20° C. to 25° C. The oxidant will normally be in solid form prior to the drying stage of the present invention, wherein the present invention removes the last vestiges of water from the oxidant which otherwise cause degradation of the oxidant. The powder is then sealed in a package under a nitrogen atmosphere. The preferred oxidant is sodium perborate. The oxidant does not require refrigeration to retains its activity.

The test method is a two stage method:

(1) A de-ionized water reference is added to the sample tube. The three agents are added and the tube introduced into the luminometer. The light output trend is measured, displayed and the trace automatically stored.

(2) A sample is then added to the tube and the reagents added and the tube introduced into the luminometer. The light output trend is again measured, displayed and stored.

The percentage light inhibition of the sample is calculated and expressed as the integral of the light output from the sample with the integral of the light output of the reference over a given time. The percentage inhibition values is calculated and displayed. Alternatively and/or additionally the percentage inhibition may be expressed as a ratio of the maximum light output from the sample divided by the maximum light output from the de-ionized reference.

FIG. 2 gives an example thereof. In the detector 10 of the present invention, result curves can be recalled onto the display and overlaid for comparison with one another. The more polluted the river the higher percentage light inhibition. In addition, different types of pollutants give different light output trends. Relatively clean rivers tend to give similar trends to the reference but with a depressed maximum. Sewage on the other hand gives a characteristic S-shaped curve.

A wide range of water quality samples have been measured. This using the above technique. This has been compared with the BOD₅ and COD tests. The correlation between the chemiluminescence test and (1) the BOD₅ between 0-300 mg/l as oxygen was 0.91 and (2) over 0.96 COD between 20-600 mg/l as oxygen. Thus the detector 10 of the present invention provides a portable technique for conducting the measuring water quality.

The detector of the present invention includes a communications port 18. The detector also has a memory circuit. The memory is designed to store at least 50 sample data. This can be downloaded via the communication port to a computer. If preferred, the detector is sold as a kit together with the necessary software to enable this downloading.

The reagents for the assay are often also sold together with the luminometer to form a kit. The kit is often sold as a case. A full kit is shown in FIG. 4. The reagents need to be stable for at least several months.

1. A method of stabilising an oxidant, comprising the steps of:
(i) drying the oxidant under vacuum to form a powder; and
(ii) packaging the powder into a sealed package in an inert atmosphere.

2. The method according to claim 1, wherein the inert atmosphere is nitrogen.

3. The method of claim 1 or claim 2, wherein the oxidant is sodium perborate.

4. The method according to any of the preceding claims, wherein the oxidant retains activity for at least 90 days at 37° C.

5. The method according to any one of the preceding claims, wherein the stabilised oxidant is stored with a drying agent.

6. The method of claim 6, wherein the drying agent is silica gel.

7. The method according to any one of the preceding claims wherein the drying step (i) is conducted at ambient temperature.

8. The method according to any one of the preceding claims wherein the oxidant is in solid form prior to step (i).

9. A stabilised oxidant comprising a dried powder which retains activity for at least 90 days at 37° C.

10. The stabilised oxidant according to claim 9, wherein the oxidant is selected from the group consisting of a sodium perborate.

11. The stabilised oxidant of claim 9 or claim 10, wherein the oxidant is provided in a package in which the oxidant was sealed in an inert atmosphere.

12. A kit including the oxidant according to claim 9, claim 10 or claim 11, and one or more of the following components:
a) a detector;
b) as an enzyme reagent;
c) a protein reagent;
d) a buffer solution;
e) luminal and/or indophenol in a pH buffer.

13. A kit according to claim 12, comprising all of components (b) to (e).

14. A kit according to claim 12 or claim 13, comprising a water test kit.

15. Use of an oxidant according to any one of claims 9 to 11, or a kit according to any one of claims 12 to 14 in an assay.

16. The use according to claim 15, wherein the assay comprises a chemiluminescence reaction.

17. A method as hereinbefore described with reference to and/or as illustrated by the accompanying drawings.

18. An oxidant as hereinbefore described with reference to and/or as illustrated by the accompanying drawings.

19. A kit as hereinbefore described with reference to and/or as illustrated by the accompanying drawings.

20. A use as hereinbefore described with reference to and/or as illustrated by the accompanying drawings.
